(19) United States
(12) Patent Application Publication
(10) Pub. No.: US 2026/0008519 A1
(43) Pub. Date: Jan. 8, 2026

(54) WIRELESS CONTROL DEVICE FOR A BICYCLE, BICYCLE, SET, COMBINATION AND METHOD

(71) Applicant: CLASSIFIED CYCLING BV, Antwerpen (BE)

(72) Inventors: Roëll Marie VAN DRUTEN, Eindhoven (NL); Arnoud Johannes MOLS, Moerqestel (NL)

(21) Appl. No.: 18/992,457

(22) PCT Filed: Jun. 21, 2023
(86) PCT No.: PCT/EP2023/066871

§ 371 Date: Jan. 8, 2025

(30) Foreign Application Priority Data
Jul. 12, 2022 (NL) 2032465
Sep. 22, 2022 (NL) 2033111

(51) Int. Cl. B62M 25/08; B62K 23/04; B62M 9/122; H01Q 1/32; H04W 4/80

(52) U.S. Cl. CPC B62M 25/08; B62K 23/04; B62M 9/122; H01Q 1/3216; H04W 4/80

(57) ABSTRACT

Wireless control device for a bicycle, bicycle, set, combination and method. Wireless control device for a bicycle, comprising: a base fixable to a handlebar of the bicycle; an operating element coupled to the base so as to be rotatable with respect to the base about a rotation axis parallel to a local center line of the handlebar when the base is fixed to the handlebar, the rotatability being at least between a plurality of predefined rotational positions including a default position and at least one activation position; and a wireless communication unit configured to wirelessly send one or more messages, including one or more control messages, in response to the operating element rotating among the predefined rotational positions according to at least one predefined sequence.

The invention concerns a wireless control device for a bicycle, as well as a bicycle provided with such a wireless control device, a set of such wireless control devices, a combination of such a wireless control device with a further wireless device, and a method of controlling a bicycle.

Wireless control devices for bicycles are known as such, for example for cooperation with a wireless gear changing device. Improvements in this area are desired.

To that end, an aspect of the invention provides a wireless control device for a bicycle, comprising: a base fixable to a handlebar of the bicycle; an operating element coupled to the base so as to be rotatable with respect to the base about a rotation axis parallel to a local center line of the handlebar when the base is fixed to the handlebar, the rotatability being at least between a plurality of rotational positions including a default position and at least one activation position; and a wireless communication unit configured to wirelessly send one or more messages, including one or more control messages, in response to the operating element rotating among the rotational positions.

The wireless sending by the wireless control device, and more generally wireless communication between wireless devices describer herein, may for example be via one or more of: Bluetooth, Bluetooth Low Energy (BTLE), ANT, ANT+, Zigbee, 6LoWPAN, Thread, WiFi, WiFi-ah, or the like, such as 2.4 GHz communication.

Optionally, the operating element is arranged to, in use, extend circumferentially around the handlebar. The operating element may e.g. include a substantially ring-shaped, e.g. cylindrical body. The substantially cylindrical shape of the operating element may be somewhat tapered, i.e. conical, and/or beveled. In particular a smaller outer diameter of the operating element may be positioned at a side facing a gripper of the handlebar. One or more protrusions and/or depressions may be provided on the outer surface of the operating element, e.g. for tactile feedback as to a rotational position of the operating element. Optionally, Optionally, base is arranged to, in use, extend circumferentially around the handlebar. The base may e.g. include a substantially ring-shaped, e.g. cylindrical body.

Optionally, the wireless communication unit is positioned so as to be between the handlebar and the operating element during use and/or so as to be enclosed by the operating element when viewed in the direction of the rotation axis. The wireless control device may include a cavity, such as an annular cavity, between the base and the operating element. The wireless communication unit may be positioned inside the cavity. Alternatively, or additionally, the wireless communication unit may be positioned inside the base and/or inside the operating element. Hence, the wireless communication unit can be shielded while the wireless control device can be designed compactly.

Optionally, the wireless communication unit is provided with an antenna. The antenna can be arranged so as to be between the handlebar and the operating element during use and/or so as to be enclosed by the operating element when viewed in the direction of the rotation axis. The antenna may be positioned inside the cavity. Alternatively, or additionally, the antenna may be positioned inside the base and/or inside the operating element.

Optionally, the wireless control device includes an activation switch(es), PCB(s), microprocessor, memory, a rechargeable or non-rechargeable battery, LED, and power input connector. The activation switch(es), PCB(s), microprocessor, memory, a rechargeable or non-rechargeable battery, LED, and power input connector can be arranged so as to be between the handlebar and the operating element during use and/or so as to be enclosed by the operating element when viewed in the direction of the rotation axis. The activation switch(es), PCB(s), microprocessor, memory, a rechargeable or non-rechargeable battery, LED, and power input connector may be positioned inside the cavity, inside the base and/or inside the operating element. Some or all of, the wireless communication unit, activation switch(es), PCB(s), microprocessor, memory, antenna, a rechargeable or non-rechargeable battery, LED, and power input connector can be mounted to the base. Alternatively, some or all of, the wireless communication unit, activation switch(es), PCB(s), microprocessor, memory, antenna, a rechargeable or non-rechargeable battery, LED, and power input connector can be mounted to the operating element. The PCB may e.g. be C-shaped or circular to be placed (partially) around the handlebar. The battery may e.g. be C-shaped or circular to be placed (partially) around the handlebar

Optionally, an inner diameter of the base is equal to or larger than an outer diameter of the handlebar, e.g. about 20 mm or 22 mm or larger. Optionally, an outer diameter of the operating element is smaller than about 50 mm, preferably smaller than about 45 mm, for example about 40 mm or smaller, so as to be relatively unobtrusive on the handlebar 4 and to be relatively easily graspable by a user. The outer diameter of smaller than about 50 mm, preferably smaller than about 45 mm, for example about 40 mm or smaller, can be measured excluding the optional one or more protrusions.

Optionally, an axial width of the operating element corresponds to, or is larger than, an axial width of the base. Hence, the operating element can essentially fully cover the base. The axial width of the operating element is preferably less than about 20 mm, more preferably less than about 15 mm.

Optionally, the at least one activation position comprises at least two activation positions, including a first activation position and a second activation position.

Optionally, the default position is rotationally between two of the at least two activation positions, in particular between the first activation position and the second activation position.

Optionally, the operating element is biased towards the default position, away from the at least one activation position, in particular away from each activation position of the at least one activation position.

Optionally, the base and the operating element are each provided with a respective biasing magnet, the biasing magnets being arranged to provide the biasing towards the default position by mutual magnetic interaction. A biasing force may also be generated by a spring or other resilient member.

Optionally, the wireless control device is configured to be arranged adjacent or in a grip for the handlebar and to continue a gripping surface of the grip when so arranged.

Optionally, the wireless control device comprises a respective activation switch for each activation position of the at least one activation position, the activation switch being configured to switch a respective electronic circuit when the operating element reaches and/or leaves the respective activation position, the electronic circuit being operatively connected with the wireless communication unit.

Optionally, the activation switch is configured to inhibit consumption of electrical power by the wireless control device while the operating element is in the default position.

Optionally, the activation switch comprises a reed switch fixed to the base, wherein a switching magnet is fixed to the operating element so as to cause switching of the reed switch depending on the operating element being in the respective activation position.

Optionally, the activation switch comprises a reed switch fixed to the operating element, wherein a switching magnet is fixed to the base so as to cause switching of the reed switch depending on the operating element being in the respective activation position.

The wireless communication unit and/or the electronic circuit can be fixedly mounted to the base. Alternatively, the wireless communication unit and/or the electronic circuit can be fixedly mounted to the operating element. Optionally, the wireless communication unit and/or the electronic circuit can be partially mounted to the base and partially mounted to the operating element.

If the at least one activation position comprises at least two activation positions, a same switching magnet may be associated with at least two of the reed switches.

Optionally, the one or more control messages include one or more gear control messages.

Optionally, the one or more messages further include a wireless pairing message.

Optionally, the wireless communication unit is configured to wirelessly send the one or more messages in response to the operating element rotating among the rotational positions according to at least one predefined sequence.

Optionally, the at least one predefined sequence comprises a sequence in which one activation position of the at least one activation position immediately follows the default position.

Optionally, the at least one predefined sequence comprises a sequence in which one activation position of the at least two activation positions follows another activation position of the at least two activation positions within a predetermined amount of time.

Optionally, the at least one predefined sequence comprises a sequence in which one activation position of the at least one activation position is continuously maintained for longer than a predetermined amount of time.

Optionally, at least one message of the one or more messages encodes at least one predefined sequence of the at least one predefined sequence.

Optionally, the wireless communication unit is configured to encode a sequence according to which the operating element is actually rotated into at least one of the one or more messages, in response to the operating element being rotated according to said sequence.

Optionally, the wireless control device stores a look up table in which the at least one predefined sequence is encoded along with a respective messaging indication, wherein the wireless control device is configured to look up the respective messaging indication in response to the operating element rotating according to the at least one predefined sequence, and to send the one or more messages in dependence of the looked up messaging indication.

Optionally, the wireless control device is configured to receive an update message regarding the look up table via the wireless communication unit and to update the look up table in response to the receiving of the update message.

A further aspect provides a bicycle provided with a wireless control device as described herein, wherein the base is fixed to a handlebar of the bicycle.

Optionally, the bicycle is provided with a further wireless control device as described herein, wherein the base of the further wireless control device is fixed to the handlebar of the bicycle at a distance from the base of the wireless control device, in particular at an opposite side of the handlebar.

Optionally, the bicycle is further provided with a wireless gear changing device configured to effect a gear change in a drive train of the bicycle in response to receiving a wireless gear control message.

Optionally, the wireless gear changing device is arranged in a hub of a wheel of the bicycle to effect a gear change from within said hub.

A further aspect provides a set of wireless control devices as described herein.

A further aspect provides a combination of at least one wireless control device as described herein and at least one further wireless device, the further wireless device being configured to receive at least one of the one or more messages from the wireless control device, at least after a pairing procedure in which the further wireless device is paired with the wireless control device.

Optionally, the further wireless device is, and/or comprises, and/or is configured to adjust, one or more of the following: a gear changing device for a bicycle, a motor for a bicycle, a shock absorber for a bicycle, a seat post for a bicycle, a light for a bicycle, a camera for a bicycle, a speaker for a bicycle, a sensor for a bicycle, a body-worn sensor, a break for a bicycle, a display for a bicycle, a navigation device for a bicycle, and a mobile device.

A further aspect provides a bicycle transmission control system for controlling a bicycle transmission having a plurality of consecutive discrete bicycle transmission ratios, the bicycle transmission comprising a first transmission connected in series to a second transmission. The first transmission includes a plurality of sprockets associated with an endless drive member, such as a chain, and an electrically actuatable derailleur. The second transmission includes an electrically actuatable internal hub transmission or internal crank transmission having at least two selectable transmission ratios. The bicycle transmission control system comprises a wireless control device as described herein, wherein the wireless control device is configured to, upon actuation of the operating element to the first activation position, control the first and/or second transmission to activate a gear upshift to the first next higher bicycle transmission ratio, and to, upon actuation of the operating element to the second activation position, control the first and/or second transmission to activate a gear downshift to the first next lower bicycle transmission ratio. The first transmission can comprise a first actuator, e.g. associated with the electrically actuatable derailleur. The second transmission can comprise a second actuator. The first transmission and the second transmission cooperate to provide the plurality of consecutive bicycle transmission ratios. First transmission ratios of the first transmission can be separated by first transmission ratio steps. Second transmission ratios of the second transmission can be separated by second transmission ratio steps. The first transmission ratio steps can be smaller than the second transmission ratio steps. The first transmission ratio steps can e.g. be 6-14%. The second transmission ratio steps can e.g. be 10-100%. Alternatively, the first transmission ratio steps can be larger than the second transmission ratio steps. Shifting from one bicycle transmission ratio to a consecutive bicycle transmission ratio may require actuation of the first transmission, the second transmission, or both. Shifting from one bicycle transmission ratio to a next higher bicycle transmission ratio may require upshifting one of the first and second transmissions in addition to downshifting the other of the first and second transmissions. Shifting from one bicycle transmission ratio to a next lower bicycle transmission ratio may require downshifting one of the first and second transmissions in addition to upshifting the other of the first and second transmissions. Hence, the wireless control device provides an intuitive control to the user for upshift and downshifting from one bicycle transmission ratio to the next. The user need not be concerned about which of the first and second transmissions needs to be controlled for achieving the desired next higher or next lower bicycle transmission ratio since the wireless control device takes care of this.

Optionally, the bicycle transmission control system comprising a further operating element. The further operating element can e.g. be a button or lever or further wireless control device as described herein. The bicycle transmission control system can be configured to, upon actuation of the further operating element, control only the second transmission to activate a gear shift. This provides an additional control allowing shifting of the second transmission only. Such shifting of the second transmission only can relate to shifting several bicycle transmission ratio steps at once. This can allow for a bail-out in case immediate downshifting of several bicycle transmission steps is desired.

Optionally, the bicycle transmission control system further comprising a further wireless control device as described herein, configured to, upon actuation of the operating element of the further wireless control device to the first activation position, control only the second transmission to activate a gear upshift, and to, upon actuation of the operating element of the further wireless control device to the second activation position, control only the second transmission to activate a gear downshift. Thus, actuation of the further wireless control device can be used for upshifting or downshifting several bicycle transmission ratio steps at once.

A further aspect provides a method of controlling a bicycle, comprising: providing a bicycle with at least one wireless control device as described herein; rotating the operating element according to one or more predefined sequences of the at least one predefined sequence, thereby causing the wireless communication unit to send one or more control messages; and by a further wireless device, receiving the one or more control messages and effecting a controlling of the bicycle in response to the receiving.

Optionally, the effecting of the controlling of the bicycle comprises effecting a gear change in a drive train of the bicycle.

Preferably, the wireless control device is wirelessly paired with the further wireless device before the effecting of the controlling.

It shall be appreciated that aspects and options disclosed herein may be variously combined. For example, features described as relating to a method may be correspondingly applied to a device and/or a system, and vice versa.

In the following, the invention will be explained further using examples of embodiments and drawings. The drawings are schematic and merely show examples. In the drawings, corresponding elements have been provided with corresponding reference signs. In the drawings:

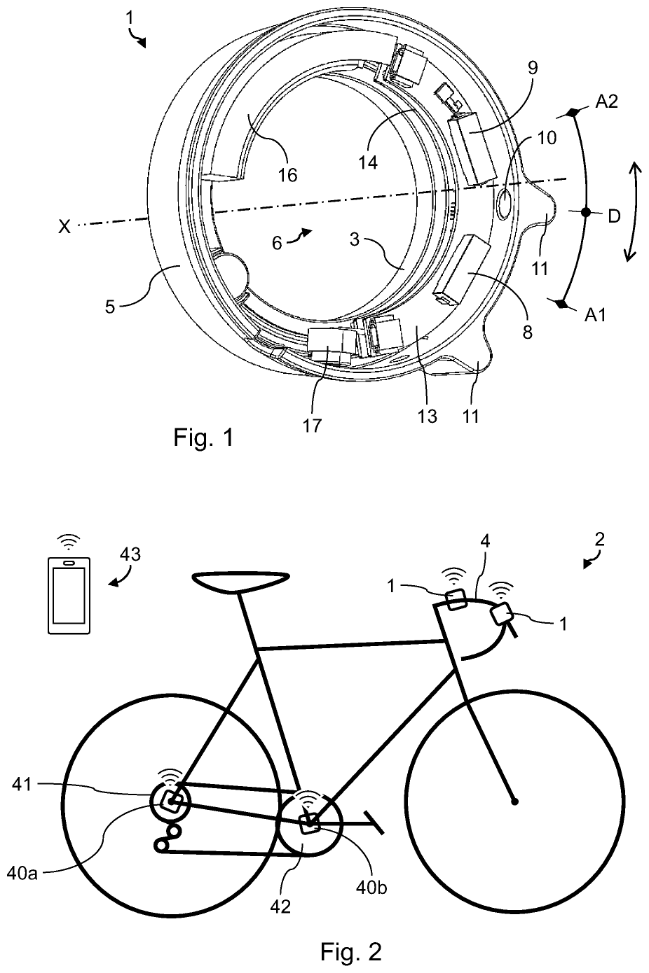

FIG. 1 shows a partly opened perspective view of a wireless control device for a bicycle;

FIG. 2 shows a bicycle provided with a wireless control device;

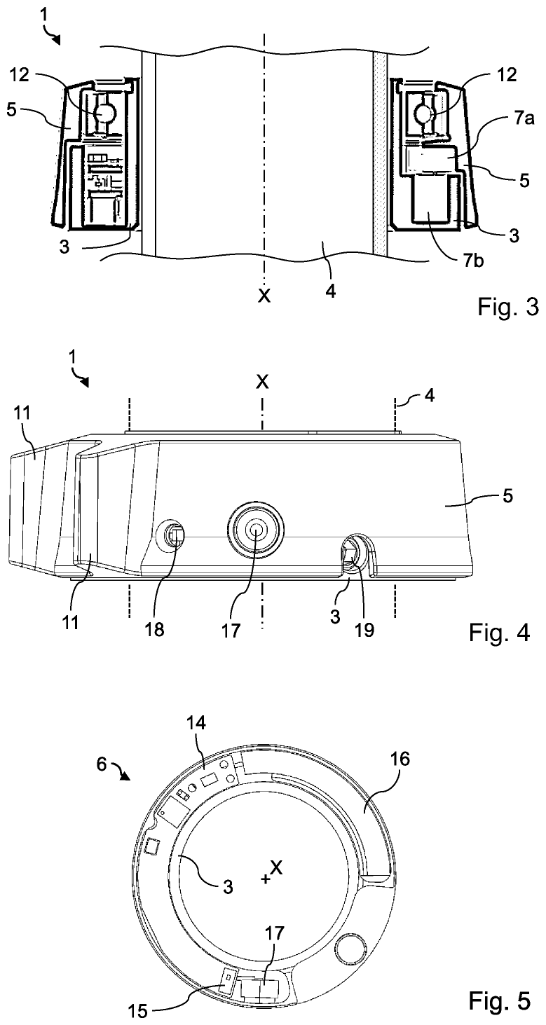

FIG. 3 shows a cross sectional side view of the wireless control device of FIG. 1;

FIG. 4 shows a bottom view of the wireless control device of FIG. 1;

FIG. 5 shows a plan view of a PCB of the wireless control device of FIG. 1; and

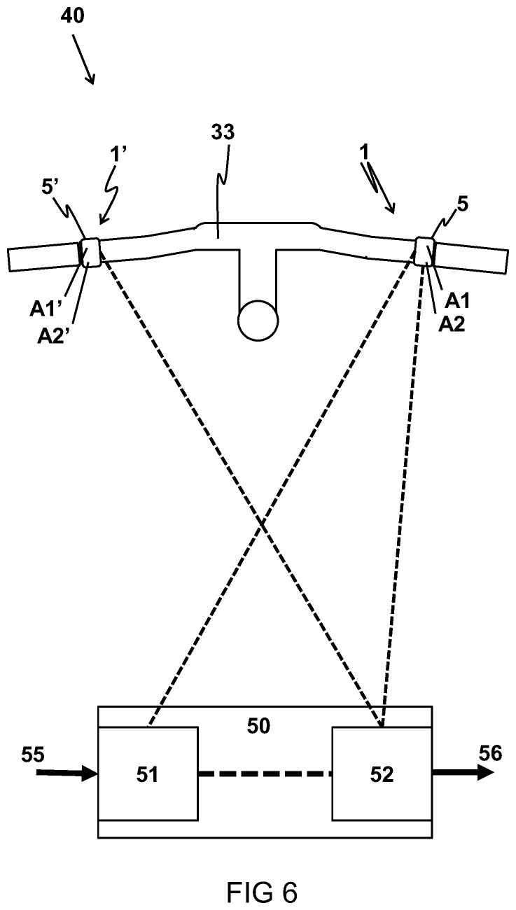

FIG. 6 shows a bicycle transmission control system.

The figures show a wireless control device 1 for a bicycle 2. The wireless control device 1 comprises: a base 3 fixable to a handlebar 4 of the bicycle 2; and an operating element 5 coupled to the base 3 so as to be rotatable with respect to the base 3 about a rotation axis X parallel to, e.g. coinciding with, a local center line of the handlebar 4 when the base 3 is fixed to the handlebar 4, the rotatability being at least between a plurality of predefined rotational positions including a default position D and at least one activation position A1, A2.

FIG. 1 shows the operating element 5 in the default position D, with activation positions A1, A2 indicated along an arc following the rotation about the rotation axis X. The operating element 5 here has an annular and substantially cylindrical shape, surrounding the base 3, and the handlebar 4 during use. The base 3 here also has an annular and substantially cylindrical shape, although in a variation the base 3 could e.g. be C-shaped so as not to surround the handlebar completely.

An inner diameter of the base 3 is preferably equal to or larger than an outer diameter of the handlebar 4, e.g. about 20 mm or 22 mm or larger. In case the inner diameter of the base 3 is large compared to the outer diameter of the handlebar 4 at a section of the handlebar 4 where the base 3 is to be fixed, an adaptor ring or the-like could be provided to overcome the size difference.

To facilitate a user in manually rotating the operating element 5, in particular against a biasing as explained elsewhere herein, the operating element 5 may be provided with one or more, here two, gripping protrusions 11. Such gripping protrusions 11 may e.g. be engaged by a thumb of the user to push or pull the operating element in a desired direction towards an activation position A1, A2, possibly in combination with or as alternative to a grasping and twisting of the operating element 5 by the user's hand. Preferably, each gripping protrusion 11 extends less than 30 degrees along the circumference of the operating element 5. An angular interspacing between gripping protrusions 11 may be between 30 and 60 degrees, for example about 45 degrees.

An outer diameter of a substantially cylindrical shape of the operating element 5, i.e. not considering the optional gripping protrusions 11, may be smaller than 50 mm, preferably smaller than 45 mm, for example about 40 mm or smaller, so as to be relatively unobtrusive on the handlebar 4 and to be relatively easily graspable by a user.

An axial width of the operating element 5 preferably corresponds to, or may be larger than, an axial width of the base 3, so that the operating element 5 essentially fully covers the base. The axial width is preferably less than 20 mm, more preferably less than 15 mm.

The shown wireless control device 1 is configured to be arranged adjacent or in a grip for the handlebar 4 and to continue a gripping surface of the grip when so arranged. The substantially cylindrical shape of the operating element 5 may be shaped and/or dimensioned accordingly. The substantially cylindrical shape of the operating element 5 may be somewhat tapered, i.e. conical, in particular with a smaller diameter at a side facing a gripper of the handlebar 4.

As shown in FIG. 3, a bearing 12, here a ball bearing, may be arranged between the base 3 and the operating element 5 to provide and/or support the rotatability of the operating element 5 with respect to the base 3, in particular while maintaining the axial position of the operating element 5 at the base 3.

The wireless control device 1 comprises a wireless communication unit 6 configured to wirelessly send one or more messages, including one or more control messages, in response to the operating element 5 rotating among the predefined rotational positions D, A1, A2, e.g. according to at least one predefined sequence. In this example, the wireless communication unit is mounted to the base. Alternatively, the wireless communication unit can be mounted to the operating element, or partially mounted to the base and partially mounted to the operating element. The wireless control device 1 can include a cavity, such as an annular cavity, between the base 3 and the operating element 5. the wireless communication unit 6 can be mounted in the cavity.

In the shown example, the at least one activation position A1, A2 comprises at least two activation positions, including a first activation position A1 and a second activation position A2.

Here, the default position D is rotationally between two of the at least two activation positions, in particular between the first activation position A1 and the second activation position A2.

Here, the operating element 5 is biased towards the default position D, away from the at least one activation position A1, A2, in particular away from each activation position A1 and A2 of the at least one activation position.

Thereto, as shown in FIG. 3, the base 3 and the operating element 5 are here each provided with a biasing mechanism, here a respective biasing magnet 7a, 7b, the biasing magnets being arranged to provide the biasing towards the default position D by mutual magnetic interaction.

Here, the wireless control device 1 comprises a respective activation switch 8, 9 for each activation position A1, A2 of the at least one activation position, the activation switches 8, 9 being configured to switch a respective electronic circuit when the operating element 5 reaches and/or leaves the respective activation position, the electronic circuit being operatively connected with the wireless communication unit 6.

Each of the activation switches 8, 9 here comprises a reed switch fixed to the base 3, wherein a switching magnet 10 is fixed to the operating element 5 so as to cause switching of the reed switch 8 or 9 depending on the operating element 5 being in the respective activation position A1 or A2. However, other switches can be contemplated.

Thereby, the activation switches 8, 9 are here configured to inhibit consumption of electrical power by the wireless control device 1 while the operating element 5 is in the default position D.

Here, the same switching magnet 10 is associated with both reed switches 8, 9.

The reed switches 8, 9 are here mounted on a PCB (printed circuit board) 13 which is here C-shaped and provides at least part of the respective electronic circuits. Such a PCB 13 may hold various other electronic components, e.g. of the wireless communication unit 6. Such other electronic components may include one or more of: a microprocessor, a memory, an antenna 15, a rechargeable or non-rechargeable battery 16, an LED 18, and a power input connector 17, e.g. for charging the battery 16 and/or for powering the device 1 directly. Such a connector 17 may be magnetic to more easily maintain a connection thereof.

Alternatively or additionally to being arranged on the PCB 13, such components may be arranged on a further PCB 14 which is here also C-shaped and stacked with respect to the PCB 13 in axial direction. In FIG. 1, the further PCB 14 is seen axially behind the PCB 13; in FIG. 5, the further PCB 14 is shown substantially from an opposite axial side. Further alternatively or additionally such other components may be arranged elsewhere, e.g. wiredly connected to one of the PCBs 13, 14. Still, all electronic components of the wireless control device 1 are preferably arranged radially inside the operating element 5.

As shown in FIG. 4, for external connections with such components, suitable openings may be provided in the operating element 5, in particular at a side thereof which during use faces downwards so as to inhibit ingress of precipitation and dirt. Further, such an opening may be provided to allow access to a fixating element 19, e.g. a bolt or a screw, for fixating the base 3 with respect to the handlebar 4.

The wireless communication unit 6 is here provided with an antenna 15 which is arranged so as to be between the handlebar 4 and the operating element 5 during use, and so as to be enclosed by the operating element 5 when viewed in the direction of the rotation axis X. To facilitate wireless communication to and from the antenna 15, the operating element 5 is preferably substantially radio transmissive, in particular non-metallic.

Optionally, the one or more control messages include one or more gear control messages.

Optionally, the one or more messages further include a wireless pairing message.

Optionally, the at least one predefined sequence comprises a sequence in which one activation position A1 or A2 of the at least one activation position immediately follows the default position D.

Optionally, the at least one predefined sequence comprises a sequence in which one activation position A1 or A2 of the at least two activation positions follows another activation position A2 or A1 of the at least two activation positions within a predetermined amount of time.

Optionally, the at least one predefined sequence comprises a sequence in which one activation position A1 or A2 of the at least one activation position is continuously maintained for longer than a predetermined amount of time.

Optionally, at least one message of the one or more messages encodes at least one predefined sequence of the at least one predefined sequence.

Optionally, the wireless communication unit 6 is configured to encode a sequence according to which the operating element 5 is actually rotated into at least one of the one or more messages, in response to the operating element 5 being rotated according to said sequence.

Optionally, the wireless control device 1 stores a look up table in which the at least one predefined sequence is encoded along with a respective messaging indication, wherein the wireless control device 1 is configured to look up the respective messaging indication in response to the operating element 5 rotating according to the at least one predefined sequence, and to send the one or more messages in dependence of the looked up messaging indication.

Optionally, the wireless control device 1 is configured to receive an update message regarding the look up table via the wireless communication unit 6 and to update the look up table in response to the receiving of the update message.

A further aspect provides a bicycle 2 provided with a wireless control device 1 as described herein, wherein the base 3 is fixed to a handlebar 4 of the bicycle.

As shown in FIG. 2, the same bicycle 2 may be provided with a further wireless control device 1 as described herein, wherein the base 3 of the further wireless control device 1 is fixed to the handlebar 4 of the bicycle at a distance from the base 3 of the wireless control device 1, in particular at an opposite side of the handlebar 4.

The wireless control devices 1 may together form a set.

Optionally, the bicycle 2 is further provided with a wireless gear changing device 40a and/or 40b configured to effect a gear change in a drive train of the bicycle 2 in response to receiving a wireless gear control message, e.g. from the wireless control device 1 and/or the further wireless control device 1.

Optionally, the wireless gear changing device 40a is arranged in a hub 41 of a wheel of the bicycle 2 to effect a gear change from within said hub 41. Alternatively or additionally, a wireless gear changing device 40b may be arranged at a crankset 42 of the bicycle 2 and/or at a motor of the bicycle 2 to effect a gear change there.

A further aspect provides a combination of at least one wireless control device 1 as described herein and at least one further wireless device 40a, 40b, 43, the further wireless device being configured to receive at least one of the one or more messages from the wireless control device 1, at least after a pairing procedure in which the further wireless device 40a, 40b, 43 is paired with the wireless control device 1.

Optionally, the further wireless device is, and/or comprises, and/or is configured to adjust, one or more of the following: a gear changing device 40a, 40b for a bicycle, a motor for a bicycle, a shock absorber for a bicycle, a seat post for a bicycle, a light for a bicycle, a camera for a bicycle, a speaker for a bicycle, a sensor for a bicycle, a body-worn sensor, a break for a bicycle, a display for a bicycle, a navigation device for a bicycle, and a mobile device 43.

FIG. 6 shows a schematic example of a bicycle transmission control system 40 for controlling a bicycle transmission 50 having a plurality of consecutive discrete bicycle transmission ratios.

In this example, the bicycle transmission 50 includes a first transmission 51 connected in series to a second transmission 52. The first transmission 51 here includes a plurality of sprockets associated with an endless drive member, such as a chain, and an electrically actuatable derailleur. The electrically actuatable derailleur includes a first shift actuator. The plurality of sprockets can e.g. be formed as a cassette. The first transmission can e.g. comprise four, five, six, seven, eight, nine, or ten sprockets, although other numbers are also possible. The first transmission 51 provides a plurality of selectable first transmission ratios by selecting which sprocket the endless drive member engages. The second transmission 52 here includes an electrically actuatable internal hub transmission having two or more selectable second transmission ratios. Alternatively, or additionally, the second transmission 52 can includes an electrically actuatable internal crank transmission having two or more selectable second transmission ratios. The electrically actuatable internal hub transmission includes a second shift actuator. In this example, a first transmission ratio step size from one first transmission ratio to the next is smaller than a second transmission ratio step size from one second transmission ratio to the next. The bicycle transmission 50, including the first transmission 51 and the second transmission 52 here provides a plurality of consecutive discrete bicycle transmission ratios. An input 55 of the transmission 50 can be can be connected to a bicycle crank. An output 56 of the transmission 50 can be connected to a driven wheel hub.

In this example, the bicycle transmission control system 40 comprises a first control device 1, and a second control device 1′. The first and second control devices 1, 1′ can be as described in view of FIGS. 1-5. In this example, the first control device 1 is configured to be operable with a user's right hand and the second control device 1′ is configured to be operable with the user's left hand. It will be clear that it is also possible that the first control device 1 is configured to be operable with a user's left hand and the second control device 1′ is configured to be operable with the user's right hand. Hence, the user has full bimanual control over the transmission system at all times. As shown in the examples of FIG. 6, the first control device 1 can be configured to be mounted at a bicycle handlebar 33 right grip portion and the second control device 1′ can be configured to be mounted at a bicycle handlebar left grip portion. Alternatively, the first control device can be configured to be mounted at a bicycle handlebar left grip portion and the second control device can be configured to be mounted at a bicycle handlebar right grip portion.

The first and second control devices 1, l′ are configured to control the bicycle transmission 50 to activate a gear shift upon actuation of one of the operating elements 5, 5′. In this example, the first control device 1 is configured to control the bicycle transmission 50 to activate a gear upshift to the first next higher bicycle transmission ratio upon actuation of operating element 5 to the first activation position A1. In this example, the first control device 1 is configured to control the bicycle transmission 50 to activate a gear downshift to the first next lower bicycle transmission ratio upon actuation of operating element 5 to the second activation position A2.

In this example, the first control device 1 is configured to determine, on the basis of the current bicycle transmission ratio, and the first next higher or first next lower bicycle transmission ratio to be switched to, which one(s) of the first transmission 51 and the second transmission 52 should be activated to change its gear ratio. It will be appreciated that an upshift to the first next higher bicycle transmission ratio of the bicycle transmission 50 may involve a downshift of the gear ratio of one of the first or second transmission 51, 52 in combination with an upshift of the gear ratio of the other one of the first and second transmission 51, 52. Similarly, a downshift to the first next lower bicycle transmission ratio of the bicycle transmission 50 may involve an upshift of the gear ratio of one of the first or second transmission 51, 52 in combination with a downshift of the gear ratio of the other one of the first and second transmission 51, 52. The first control device 1 thus controls one or more shift actuators of the bicycle transmission 50 in response to the upshift or downshift command provided by the cyclist. Depending on the bicycle transmission ratio used at that point in time, the next higher bicycle transmission ratio can be obtained by actuating one or more shift actuators. The first control device 1 may be configured to select and actuate the appropriate shift actuator(s) of the first and second transmission. For example, a gearshift to the next higher bicycle transmission ratio may involve a gearshift with the internal hub transmission 52 as well as with e.g. a rear derailleur 51, whereas the user needs to make only one gearshift command, as the first control device 1 activates both the shift actuators accordingly. Shifting is thus simplified for the user. The one or more shift actuators can be arranged for being operated electronically by the first control device 1. The bicycle transmission 50 can be arranged such that the bicycle transmission ratios through which can be shifted can be chosen or adapted by the user.

In this example, the second control device 1′ is configured to control the bicycle transmission 50 to control only the second transmission 52, here the electrically actuatable internal hub transmission. Here, the second control device 1′ is configured to control only the second transmission 52, here the electrically actuatable internal hub transmission, to activate a gear upshift to a higher second transmission ratio upon actuation of operating element 5′ to the first activation position A1′. Here, the second control device 1′ is configured to control only the second transmission 52, here the electrically actuatable internal hub transmission, to activate a gear downshift to a lower second transmission ratio upon actuation of operating element 5′ to the second activation position A2′.

In the example of FIG. 6, the first and second control devices 1, 1′ include a transmitter for wirelessly transmitting a gear shift command to the bicycle transmission system 50.

In case the second transmission 52 comprises only two second transmission ratios, the second control device 1′ can be configured to control only the second transmission 52, such as the electrically actuatable internal hub transmission or electrically actuatable internal crank transmission, to activate a gear shift upon actuation of operating element 5′ to the first activation position A1′. The gearshift of the second transmission 52 in this example can be from the present second transmission ratio to the other second transmission ratio. Hence, upon actuation of operating element 5′ to the first activation position A1′ in this example the second transmission 52 can either shift up or shift down, depending on the present second transmission ratio. In this example, a first transmission ratio step size from one first transmission ratio to the next can be smaller than a second transmission ratio step size from the first second transmission ratio to the second transmission ratio. Therefore, actuation of the second control device 1′ can cause a change in bicycle transmission ratio that is larger than a change to the first next higher or first next lower bicycle transmission ratio. It will be appreciated that the gearshift of the second transmission 52 can also be actuated using an alternative control device, e.g. including an activation button.

A further aspect provides a method of controlling a bicycle 2, comprising: providing a bicycle 2 with at least one wireless control device 1 as described herein; rotating the operating element 5 according to one or more predefined sequences of the at least one predefined sequence, thereby causing the wireless communication unit 6 to send one or more control messages; and by a further wireless device 40a, 40b, 43 receiving the one or more control messages and effecting a controlling of the bicycle 2 in response to the receiving.

Optionally, the effecting of the controlling of the bicycle 2 comprises effecting a gear change in a drive train of the bicycle 2.

Preferably, the wireless control device 1 is wirelessly paired with the further wireless device 40a, 40b, 43 before the effecting of the controlling.

It will be appreciated that some or all of, the wireless communication unit, activation switch(es), PCB(s), microprocessor, memory, antenna, a rechargeable or non-rechargeable battery, LED, and power input connector can be mounted to the base. Alternatively, some or all of, the wireless communication unit, activation switch(es), PCB(s), microprocessor, memory, antenna, a rechargeable or non-rechargeable battery, LED, and power input connector can be mounted to the operating element.

Although the invention has been explained further herein using examples of embodiments and drawings, these do not limit the scope of the invention as defined by the claims. Within said scope, many variations, combinations and extensions are possible, as will be appreciated by the skilled person.

1. A wireless control device for a bicycle, comprising:
a base fixable to a handlebar of the bicycle;
an operating element coupled to the base so as to be rotatable with respect to the base about a rotation axis parallel to a local center line of the handlebar when the base is fixed to the handlebar, the rotatability being at least between a plurality of rotational positions including a default position and at least one activation position; and
a wireless communication unit configured to wirelessly send one or more messages, including one or more control messages, in response to the operating element rotating among the plurality of rotational positions.

2. The wireless control device according to claim 1, wherein the operating element is arranged to extend circumferentially around the handlebar.

3. The wireless control device according to claim 2, wherein the operating element is substantially ring-shaped, such as substantially cylindrical, optionally tapered and/or beveled, optionally including one or more protrusions and/or depressions.

4. The wireless control device according to claim 1, wherein the wireless communication unit is positioned so as to be between the handlebar and the operating element during use and/or so as to be enclosed by the operating element when viewed in the direction of the rotation axis.

5. The wireless control device according to claim 1, wherein the wireless communication unit is provided with an antenna which is arranged so as to be between the handlebar and the operating element during use and/or so as to be enclosed by the operating element when viewed in the direction of the rotation axis.

6. The wireless control device according to claim 1, wherein an inner diameter of the base is equal to or larger than an outer diameter of the handlebar, e.g. about 20 mm or about 22 mm or larger.

7. The wireless control device according to claim 1, wherein an outer of diameter the operating element is smaller than about 50 mm, preferably smaller than about 45 mm, for example about 40 mm or smaller.

8. The wireless control device according to claim 3, wherein an outer diameter the operating element, excluding the one or more protrusions, is smaller than about 50 mm, preferably smaller than about 45 mm, for example about 40 mm or smaller.

9. The wireless control device according to claim 1, wherein an axial width of the operating element corresponds to, or is larger than, an axial width of the base.

10. The wireless control device according to claim 9, wherein the axial width of the operating element is less than about 20 mm.

11. The wireless control device according to claim 1, wherein the at least one activation position comprises at least two activation positions, including a first activation position and a second activation position.

12. The wireless control device according to claim 11, wherein the default position is rotationally between two of the at least two activation positions, in particular between the first activation position and the second activation position.

13. The wireless control device according to claim 1, wherein the operating element is biased towards the default position, away from the at least one activation position, in particular away from each activation position of the at least one activation position.

14. The wireless control device according to claim 13, wherein the base and the operating element are each provided with a respective biasing magnet, the biasing magnets being arranged to provide the biasing towards the default position by mutual magnetic interaction.

15. The wireless control device according to claim 1, configured to be arranged adjacent or in a grip for the handlebar and to continue a gripping surface of the grip when so arranged.

16. The wireless control device according to claim 1, comprising a respective activation switch for each activation position of the at least one activation position, each activation switch being configured to switch a respective electronic circuit when the operating element reaches and/or leaves the respective activation position, the electronic circuit being operatively connected with the wireless communication unit.

17.-19. (canceled)

20. The wireless control device according to claim 1, wherein the one or more control messages include one or more gear control messages.

21. The wireless control device according to claim 1, wherein the one or more messages further include a wireless pairing message.

22. The wireless control device according to claim 1, wherein the wireless communication unit is configured to wirelessly send the one or more messages in response to the operating element rotating among the rotational positions according to at least one predefined sequence.

23.-29. (canceled)

30. A bicycle transmission control system for controlling a bicycle transmission having a plurality of consecutive discrete bicycle transmission ratios, the bicycle transmission comprising a first transmission connected in series to a second transmission, wherein:
the first transmission includes a plurality of sprockets associated with an endless drive member, such as a chain, and an electrically actuatable derailleur; and
the second transmission includes an electrically actuatable internal hub transmission or internal crank transmission having at least two selectable transmission ratios;
the control system comprising:
the wireless control device according to claim 11 configured to:
upon actuation of the operating element to the first activation position, control the first and/or second transmission to activate a gear upshift to the first next higher bicycle transmission ratio; and
upon actuation of the operating element to the second activation position, control the first and/or second transmission to activate a gear downshift to the first next lower bicycle transmission ratio.

31. The bicycle transmission control system according to claim 30, comprising a further operating element, the control system being configured to, upon actuation of the further operating element, control only the second transmission to activate a gear shift.

32. The bicycle transmission control system of claim 30, further comprising a further wireless control device comprising an operating element coupled to a base so as to be rotatable with respect to the base about a rotation axis parallel to a local center line of the handlebar when the base is fixed to the handlebar, the rotatability being at least between a plurality of rotational positions including a default position and at least two activation positions, including a first activation position and a second activation position; and a wireless communication unit configured to wirelessly send one or more messages, including one or more control messages, in response to the operating element rotating among the plurality of rotational positions, the bicycle transmission control system configured to:
upon actuation of the operating element of the further wireless control device to the first activation position, control only the second transmission to activate a gear upshift; and
upon actuation of the operating element of the further wireless control device to the second activation position, control only the second transmission to activate a gear downshift.

33. A bicycle with the wireless control device according to claim 20, wherein the base is fixed to a handlebar of the bicycle.

34. The bicycle according to claim 33, further comprising a further wireless control device comprising an operating element coupled to a base so as to be rotatable with respect to the base about a rotation axis parallel to a local center line of the handlebar when the base is fixed to the handlebar, the rotatability being at least between a plurality of rotational positions including a default position and at least one activation position; and a wireless communication unit configured to wirelessly send one or more messages, including one or more control messages, in response to the operating element rotating among the plurality of rotational positions, wherein the base of the further wireless control device is fixed to the handlebar of the bicycle at an opposite side of the handlebar.

35. The bicycle according to claim 33, further provided with a wireless gear changing device configured to effect a gear change in a drive train of the bicycle in response to receiving a wireless gear control message.

36.-37. (canceled)

38. A combination of at least one wireless control device according to claim 1 and at least one further wireless device, the at least one further wireless device being configured to receive at least one of the one or more messages from the at least one wireless control device, at least after a pairing procedure in which the at least one further wireless device is paired with the at least one wireless control device.

39. The combination according to claim 38, wherein the at least one further wireless device comprises, and/or is configured to adjust, one or more of the following: a gear changing device for a bicycle, a motor for a bicycle, a shock absorber for a bicycle, a seat post for a bicycle, a light for a bicycle, a camera for a bicycle, a speaker for a bicycle, a sensor for a bicycle, a body-worn sensor, a break for a bicycle, a display for a bicycle, a navigation device for a bicycle, and a mobile device.

40.-42. (canceled)
